(19) United States
(12) Patent Application Publication
(10) Pub. No.: US 2024/0288021 A1
(43) Pub. Date: Aug. 29, 2024

(54) Fastener Assembly for Use in Corrosive Environments

(71) Applicant: SANDVIK ROCK PROCESSING AUSTRALIA PTY LIMITED, North Ryde NSW (AU)

(72) Inventors: Andreas WIELTSCH, North Ryde NSW (AU); Simon MANN, North Ryde NSW (AU)

(21) Appl. No.: 18/572,856

(22) PCT Filed: Jun. 21, 2022
(86) PCT No.: PCT/AU2022/050625

§ 371 Date: Dec. 21, 2023

(30) Foreign Application Priority Data
Jun. 23, 2021 (AU) 2021901882

(51) Int. Cl. F16B 33/00; F16B 35/00; F16B 37/14

(52) U.S. Cl. CPC F16B 33/008; F16B 33/004; F16B 35/005; F16B 37/145

(57) ABSTRACT

The specification discloses a fastener assembly (10) having a bolt stud or pin (13) with a threaded section (15) at one end, a nut member (11) threadable onto the threaded section (15), the fastener assembly (10) further including a cup shaped cover member (30) with a continuous wall structure having an internal surface defining an internal space (42), the continuous wall structure having an open mouth region (33) with a seal zone (35) and a continuous seal member (32), the internal surface (43, 44) of the cover member (30) having first snap-in formations (45) cooperating with second snap-in formations (48) on an outer surface region of the threaded nut member (11) to prevent disengagement of the cover member (30) from the nut member (11) and to press said continuous seal member (32), in use, against a sealing region around said nut member (11) to thereby prevent ingress of contaminants and corrosive materials into the internal space (42).

### TECHNICAL FIELD

The present development relates to the field of protecting fastener assemblies such as nut and bolt arrangements including multi jackbolt tensioner type fastener assemblies used in corrosive environments.

The development has occurred specifically in the field of treatment apparatus and particularly, fastener assemblies used to secure vibration exciter devices to screening apparatus having at least one treatment deck, including screening deck(s), however it will be apparent that the development is potentially applicable to fastening assemblies used in many other corrosive environments.

### BACKGROUND ART

Throughout this specification including the accompanying patent claims, reference to “treatment apparatus” is intended to refer to screening apparatus, screening and impact apparatus, impact decks and auxiliary equipment therefor including feed equipment and particularly vibratory feeders, and parts thereof including vibration exciter devices. Screening apparatus, in use, receives any particulate material of varying sizes including but not limited to rock, ore or earth materials, to separate the material into one or more particle size ranges. Such treatment apparatus may also include other processes including dewatering processes, cleaning processes and transport processes. Treatment apparatus and parts thereof are often subject to difficult dynamic loading conditions which may also occur in corrosive environments and often with the presence of damaging debris and other contaminants. It is common place for parts of such treatment apparatus including fastener assemblies to be replaced from time to time because of significant deterioration as a result of the use environment. Specifically, corrosion and other effects can cause threaded nut members to seize on the fastener bolt or shaft making it difficult to remove same. In some cases, such fastener assemblies need to be cut off the structure as opposed to being released in a normal manner. This is difficult and dangerous work.

An objective of the present development is to provide an improved protective arrangement for fastener assemblies used in corrosive environments to enable the fastener assembly to have increased useful life and to be releasable in a normal manner when desired. A further objective is to provide an improved fastener assembly particularly for securing vibration exciter devices to screening apparatus.

### SUMMARY OF THE INVENTION

According to a first aspect of this disclosure there is provided a fastener assembly for securing a first member or assembly to a second member or assembly, the fastener assembly including a pin, stud or bolt with a screw thread formation on a shaft portion, the thread formation being cooperable with a threaded nut member, the fastener assembly further including a cup shaped cover member with a continuous wall structure having an internal surface defining an internal space, the continuous wall structure having an open mouth region with a continuous peripheral edge zone, said internal surface of said cover member having first snap-in formation means cooperable with second snap-in formation means on an outer surface region of the threaded nut member to secure said outer cover member to said threaded nut member, and in use when so secured, said continuous peripheral edge zone is positioned closely adjacent to a first region surrounding said threaded nut member, said first and said second snap-in formation means being configured to either prevent rotation of said cover member relative to said threaded nut member, or if relative rotation is possible, said first and second snap-in formation means remain engaged upon such relative rotation. Preferably, said cover member may have either or both:

a continuous seal member positioned along said continuous peripheral edge zone whereby, in use, said continuous seal member is sealed to said first region surrounding said threaded nut member upon interengagement of said first and said second snap-in formation means, and/or said internal space is filled or substantially filled with a blocking filler material configured to, in use, minimize or prevent ingress of corrosive or other contaminant materials passing into contact with said pin, stud or bold or said threaded nut member.

Preferably, the first member or assembly may be part of vibratory apparatus, for example, a vibration exciter device, and the second member or assembly may be apparatus vibrated, at least in part, by said vibration exciter device, such as vibratory impact or screening apparatus having at least one screening deck, and vibratory feeder apparatus for feeding treatment material to impact or screening apparatus. Vibratory apparatus may, however, include machinery other than those specifically identified above.

The first and the second snap-in formation means need to be sufficiently robust to prevent disengagement when subject to normally acting dynamic loading forces during use of same, and thereby remain operationally effective to protect the pin, stud or bolt and the threaded nut member when in use.

According to a second aspect of this disclosure there is provided vibratory apparatus having at least one member or assembly vibrated by at least one vibration exciter device mounted to said vibratory apparatus by at least one said fastener assembly including a pin, stud or bolt with a thread formation on a shaft portion and a threaded nut member engaging with said thread formation on the shaft portion, the fastener assembly further including a cup shaped cover member with a continuous wall structure having an internal surface defining an internal space, the continuous wall structure having an open mouth region with a continuous peripheral edge zone, said internal surface of said cover member having first snap-in formation means cooperable with second snap-in formation means on an outer surface region of the threaded nut member to secure said cover member to said threaded nut member, and in use when so secured, said continuous peripheral edge zone is positioned closely adjacent to a seal zone surrounding said threaded nut member, said first and said second snap-in formation means being configured to either prevent rotation of said outer cover member relative to said threaded nut member, or if relative rotation is possible, said first and said second snap-in formation means remain engaged upon such relative rotation.

Preferably, said cover member may have either or both:
a continuous seal member positioned along said continuous peripheral edge zone whereby, in use, said continuous seal member is sealed to said seal zone surrounding said threaded nut member upon interengagement of said first and said second snap-in formation means, and/or
said internal space is filled or substantially filled with a blocking filler material configured to, in use, minimize or prevent ingress of corrosive or other contaminant materials, including liquid or semi-liquid corrosive materials, passing into contact with said pin, stud or bolt or said threaded nut member.

Conveniently, the outer surface region of the threaded nut member includes drive surfaces cooperable with a manual or powered tool member to rotate said threaded nut member relative to the threaded shaft portion. Preferably, the drive surfaces are configured to engage with any suitable head engagement tool member including, but not limited to, a hexagonal head configuration.

In one preferred arrangement, the outer surface region of the threaded nut member has at least two axially formed zones, a first outer zone being of smaller transverse size than a transverse size of a second inner zone. Conveniently, the second inner zone is circular in cross-section with the first outer zone being co-axially disposed relative to the second inner zone. The first outer zone having a basic hexagonal cross-sectional shape to form the aforesaid drive surfaces. Preferably, the second snap-in formation means are also formed on the first outer zone having discrete sections of the second snap-in formations spaced about a circumferential region of the first outer zone, and preferably they are arranged on portions of a circular arc co-axial with the second inner zone.

In one preferred arrangement a multi jackbolt tensioner assembly is utilised as the threaded nut member, said multi jackbolt tensioner assembly having a nut body and a plurality of threaded jackbolt members positioned about a central threaded bore engageable with the thread formation on the shaft portion, each of said threaded jackbolt members being threadable through threaded bores in the nut body.

Conveniently the fastener assembly, either with a conventional threaded nut member or in the form of a multi jack bolt tensioner assembly is intended for use in fastening two parts of an assembly subject to dynamic loading forces applied in vibratory apparatus including treatment apparatus and vibratory feeder apparatus for impact and screening apparatus.

Conveniently, in a first possible preferred embodiment, the cup shaped cover member may be formed in one piece from a single material. Preferably, the single material may be a corrosion resistant metal or a corrosion resistant polymer material including polyurethane.

In a still further possible preferred embodiment, the cover member of the above described fastener assemblies may be formed by constructing the continuous wall structure from at least two parts, a first outer part and the internal surface being formed, at least partly, on at least one second inner part. The first outer part may be metallic and preferably may be made from a corrosion resistant metal. Conveniently, the or each said second inner part may be made from a polymer material including polyurethane. The second inner part or parts may each be separately formed and mechanically connected to the first outer part and/or be bonded to the first outer part. Alternatively the second inner part may be a single part having a single or integral wall structure defining the internal surface of the cover member. In a still further possible construction the second inner part or parts may be moulded onto the first outer part.

In a possible still further preferred embodiment, the threaded nut member has a second outwardly located part or parts secured to, or bonded to, a nut body part, the second snap-in formation means being formed on said second outwardly located part or parts.

In a still further preferred embodiment, the present disclosure provides a cover member for use with a fastener assembly having a pin, stud or bolt with a screw thread formation on a shaft portion and a threaded nut member threadingly engageable with the screw thread formation on the shaft portion of the pin, stud or bolt, said cover member having a continuous wall structure in a cup shape having an internal surface defining an internal space larger than at least said threaded nut member, the continuous wall structure having an open mouth region with a continuous peripheral edge zone and a continuous seal member positioned along said continuous peripheral edge zone, said internal surface of said cover member having first snap-in formation means cooperable with second snap-in formation means on an outer surface region of the threaded nut member, in use, to secure said cover member to said nut member, said first snap-in formation means, cither alone or in combination with said second snap-in formation means either prevent rotation of said cover member relative to said threaded nut member, or if relative rotation is possible, said first and said second snap-in formation means remain engaged upon such relative rotation, said first snap-in formation means being configured such that when engaged with said second snap-in formation means, said continuous seal means is operable, in use, to seal said internal space. Conveniently, the continuous peripheral edge zone has a mounting zone for said continuous seal member, said mounting zone including a ring groove formation.

Preferably, the continuous wall structure has a first zone more distant from said continuous peripheral edge zone and a second zone adjacent said continuous peripheral edge zone, each of said first zone and said second zone having a circular cross-section with said first zone having a smaller diameter than that of said second zone. Conveniently, the cover member may further include a third zone of circular cross-section positioned axially further away from said continuous peripheral edge zone than said first zone, said third zone having a smaller diameter than said first zone. Preferably the first snap-in formation means are formed on the internal surface of said first zone, said first snap-in formation means being at least one continuous groove extending into said internal surface or at least one continuous rib extending from said internal surface into said internal space. The first snap-in formation means may include multiple axially spaced said continuous grooves or multiple axially spaced said continuous ribs. Alternatively, the groove(s) or the rib(s) may not be continuous but, in use, have sufficient length and are positioned to remain engaged with the second snap-in formation means regardless of rotational position of said cover member relative to said threaded nut member. It has further been found that the cooperating grooves and rib configurations satisfactorily remain in operational interengagement under all expected dynamic loading conditions experienced by such fastener assemblies.

It will be understood that any terms such as “comprises”, “comprising”, “includes” and/or “including” when used in this specification, specify the presence of stated features, items, steps, operations, elements, materials, and/or components, but do not preclude the presence of or addition of one or more other features, items, steps, operations, elements, components, materials and/or groups thereof. The disclosure of this specification should also be regarded as including the subject matter of the claims as annexed.

### BRIEF DESCRIPTION OF THE DRAWINGS

FIG. 1 shows a side elevation view of a vibration exciter device secured to part of screening apparatus by a fastener assembly as disclosed herein;

FIG. 2 shows an end elevation view of FIG. 1;

FIG. 3 shows a partial detail view of the region identified by A in FIG. 2;

FIG. 4 shows a section view through the fastener assembly shown in FIG. 1;

FIG. 5 shows in section further details of the fastener assembly shown in FIG. 4;

FIG. 6 shows a top plan view of the nut member of the fastener assembly shown in FIG. 5;

FIG. 7 is a section view along line A-A of FIG. 6;

FIG. 8 is a side elevation view of the nut member of FIG. 6;

FIG. 9 is a transverse section view through the cover member of the assembly shown in FIG. 5;

FIG. 10 is a detail of the area marked A in FIG. 9;

FIG. 11 is an outer perspective view of the cover member shown in FIG. 10; and

FIG. 12 is an upper perspective view of the nut member shown in FIGS. 6, 7 and 8.

### DESCRIPTION OF PREFERRED EMBODIMENTS

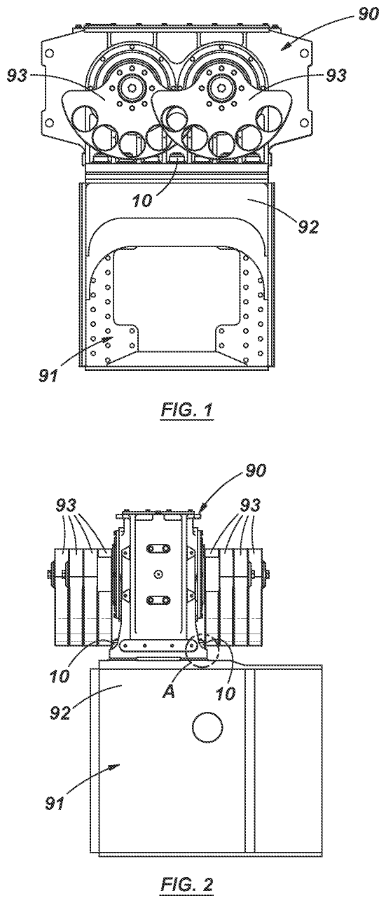

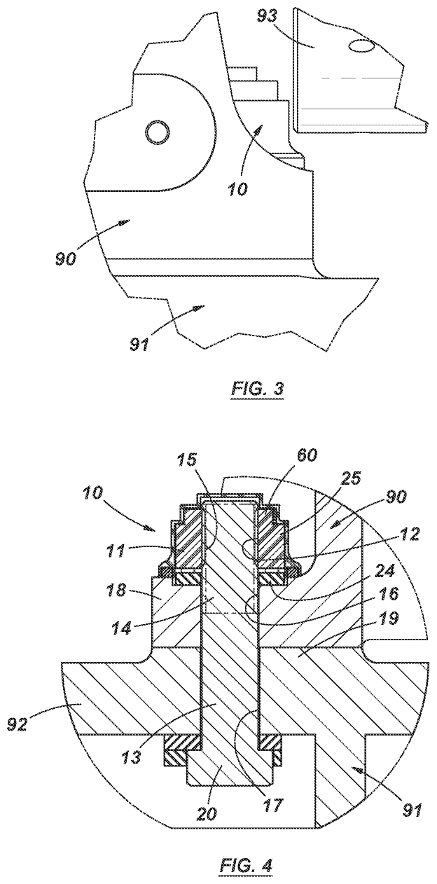

FIGS. 1 and 2 represent a vibration exciter cell 90 mounted to treatment apparatus 91 only part of which is shown as a support beam 92. The treatment apparatus 91 may include at least one and normally two or more screening decks (not illustrated) arranged in a stack above one another. The vibration exciter cell or cells 90 are mounted to the treatment apparatus 91 by multiple fastener assemblies 10, one of which is shown in FIGS. 3/4. Each vibration exciter cell 90 may have four (or more) spaced fastener assemblies 10, further details of which will be described below. The positioning of the vibration exciter cells 90 may vary. For example, they can be positioned above a screening deck of treatment apparatus 91 or to side walls of same, or perhaps in other locations but this does not greatly affect the present development. The force loading on the fastener assemblies 10 securing vibration exciter cells to treatment apparatus 91 is normally high with high cycle counts of vibrations imposed on the fastener assemblies 10 also making it a difficult environment for the fastener assemblies 10. The relative frequency of vibration does not affect whether the present development is useful or not. In addition, treatment apparatus 91 often work in corrosive environments caused by rock dust and grit together with corrosive liquids. Each vibration exciter cell 90 typically includes multiple eccentric weights 93 that are moved about a rotation axis to create a desired vibration. As shown in FIG. 3, the eccentric weights 93 may be moving in close proximity to other parts such as, for example, a fastener assembly 10 limiting the space available for the fastener assembly 10, including installing and removal, when desired, of one or more such fastener assembles 10.

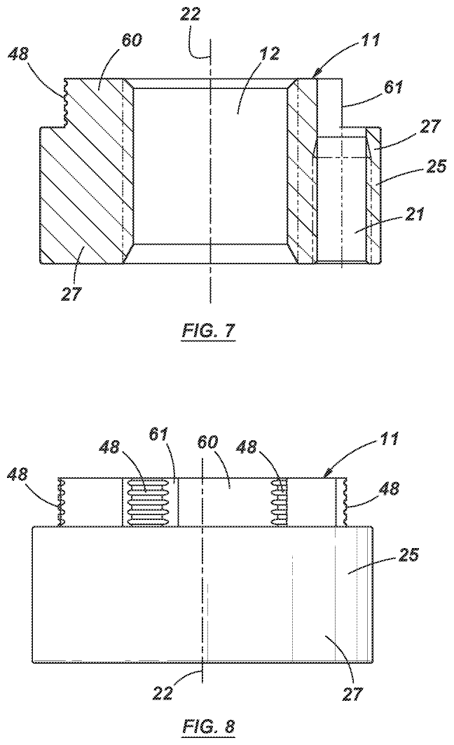

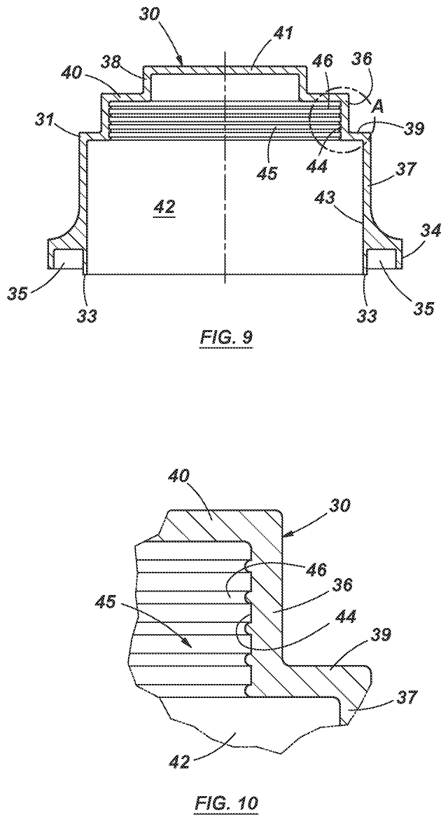

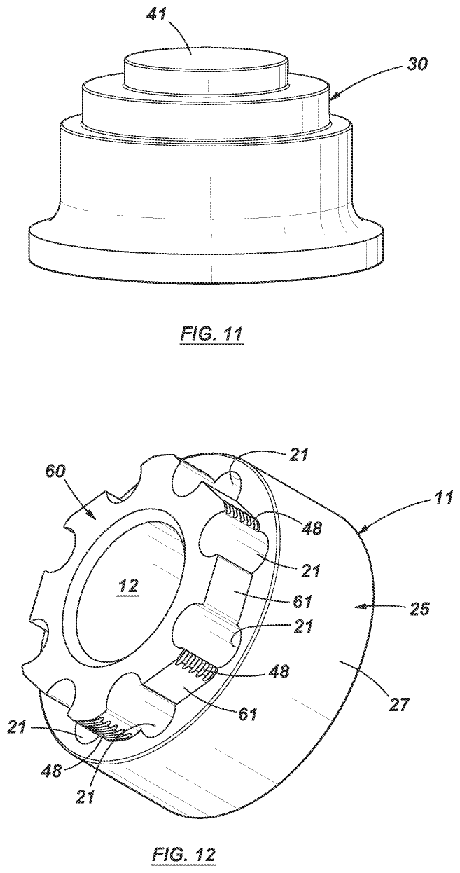

Referring now to FIGS. 4 to 12, details of one possible preferred form of fastener assembly 10 are illustrated. The fastener assembly 10 includes a multi jackbolt tensioner (MJT) arrangement comprising a nut member 11 with a central threaded bore 12 and a bolt member 13 having a shaft portion 14 with a threaded region 15 positioned at one end threadingly engaged in the threaded bore 12 of the nut member 11. The bolt member 13 passes through aligned bores 16, 17 in a mounting flange portion 18 of the vibration exciter cell 90 and a mounting zone 19 of the treatment apparatus 91. The bolt member 13 further includes a head part 20 whereby rotation of the nut member 11 on the thread region 15 of the bolt member 13 causes the flange portion 18 to be pressed against the mounting zone 19 of the treatment apparatus 91. The structure of the illustrated nut member 11 is that it may include eight jackbolt members 20 threadingly engaged in threaded bores 21 arranged at equal radii from the axis 22 and generally equally spaced around the nut member 11 as can be seen in FIG. 6. The top of each jackbolt member 20 has a drive recess 23 formed therein and this drive recess 23, as illustrated is a hexagonal drive bore. Other configurations for the drive recess 23 can also be employed. Still further, it may be possible to have a drive member formed as an axially extending protrusion rather than a recess as illustrated. As is known with multi jackbolt tensioner arrangements, the jackbolt members 20 are screwed down on to a pressure washer 24 to establish essentially a known and desired tension force level in the bolt member 13 to a desired degree, and with greater accuracy, than can be established with a conventional nut on a conventional threaded bolt. It may be, however, that in some other applications, the advantages achievable with a multi jackbolt tensioner arrangement may not be necessary and in this circumstance, a conventional nut member might be employed, albeit modified with other features of the following disclosure.

As can be seen in FIGS. 4 to 8, the illustrated nut member includes a first axially outer zone 60 and a second axially inner zone 25. The second axially inner zone 25 has a circular outer surface and the first axially outer zone has a generally hexagonal configuration (FIG. 6) with a transverse dimension less than that of the second axially inner zone 25. Each of the axial bores 21 have axes positioned on a common radius circle 26 and partially pass through the axial wall 61 of the first axially outer zone 60. The hexagonal configuration of the first axially outer zone 60 causes the axial wall to have drive surfaces 61 engageable with a hexagonal drive tool that might be operated manually or by power means to enable the nut member 11 to be rotated on the bolt member 13. While the drawings show a hexagonal shaped drive head, other configurations for the drive head are also possible. In the illustrated, hexagonal head configuration, the corners of the hexagonal shape have been removed to ensure the first outer zone 60 does not extend radially beyond an imaginary circle line 28 as will be further explained below.

FIGS. 4 to 11 illustrate a cover member 20 with a closed outer wall 31 in a cup shape defining an internal space 42 with an open mouth region 33 defined by a peripheral edge zone 34. The peripheral edge zone 34 defines a peripheral seal seat 35 that is a ring groove enabling a ring seal member 32 to be positioned and retained therein. The seal member 32 may be an O-ring type seal member, but other seal members could also be used.

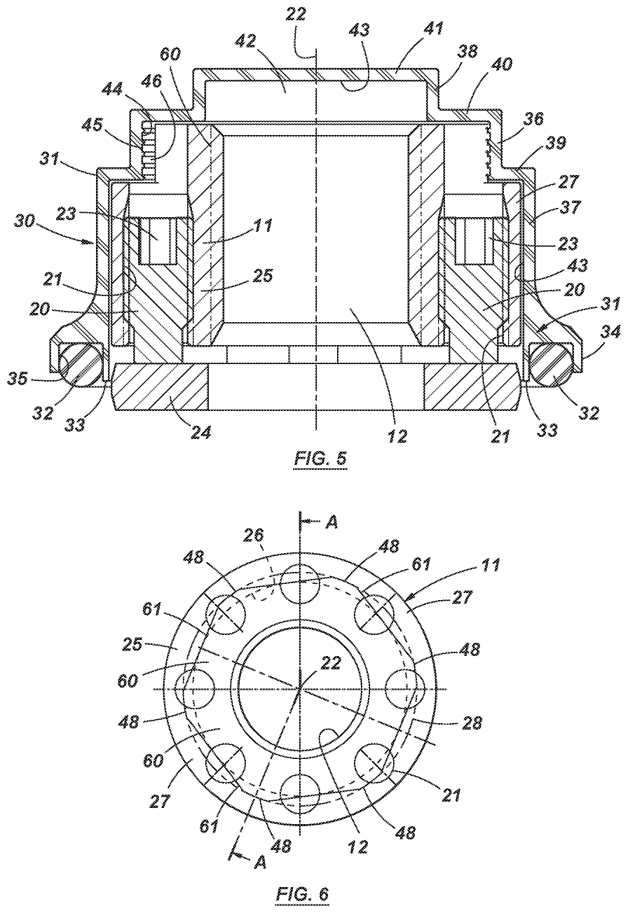

The cover member 30 has a first zone 36, a second zone 37 and a third zone 38, each being annularly formed and connected by ledge zones 39, 40, and with the third zone 38 having a closing outer wall 41 to define the internal space 42 having an inwardly facing wall surface 43. The diameter of the inwardly facing wall surface 43 of the second zone 37 is slightly greater than the outer wall surface of the second inner zone 25 of the nut member 11 and, in use fits over same as shown in FIG. 5. The inner surface 44 of the first zone 36 has a diameter generally equivalent to that of the imaginary circle line 28 and includes circumferential first snap-in formation means 45 in the form of parallel ribs 46. The portions of the axial wall 61 of the nut member 11 extending along the line 28 has second snap-in formation means 47 in the form of grooves 48, complementary to the first snap-in formation means 45. In the illustrated embodiment, the complementary ribs 46 and grooves 48 are semi-circular in form but other configurations are possible including square/rectangular, trapezoidal and triangular. The configuration is such that the cover member 30 can be positioned over the nut member 11 with the inner second zone 25 of the nut member 11 providing a guide for axial movement of the cover member 30. The cover member 30 can then be pressed axially until the ledge wall 39 engages the top of the second inner zone 25 and by this stage the first and the second snap-in formation means 45, 47 have been engaged and the seal member 32 has been engaged against a first region establishing a seal surface surrounding the nut member 11. In this position, the internal space 42 is sealed thereby protecting the internally located nut assembly from ingress of contaminant and corrosive materials. The ribs 46 and cooperating grooves 48 forming the first and the second snap-in formation means 45, 47 provide a secure connection between the cover member 30 and the nut member 11 while operationally pressing the seal member 32 against the seal zone surface under the dynamic loading conditions imposed on the fastening assembly during normal operational use. The same secure interconnection is achieved with embodiments not utilizing a seal member 32 as described herein.

In another possible preferred embodiment, the internal space 42 might be filled or partially filled with a suitable blocking flowable filler material such as grease or some other similar material capable of preventing ingress of corrosive liquid or semi liquid from externally of the fastener assembly 10, or the ingress of particle material that might adversely affect the operation of the fastener assembly 10. The filling or substantial filling of the internal space 42 with such blocking flowable filler material might be used with the provision of a seal member 32 or in the absence of such a seal member 32 provided the peripheral edge zone 34 of the cover member 30, in an operational position, is located closely adjacent or engaging the first region surrounding the nut member 11.

It will be recognised by those skilled in this art that, while the illustrations show one preferred embodiment, variations are possible within the scope of the accompanying claims. For example, the positioning of the first and the second snap-in formation means might be rearranged, for example between the outer wall of the second zone 27 of the nut member 11 and inner wall surface 43 of the second zone 37 of the cover member 30. Variations to the structure of the multi jackbolt tensioner arrangement might also be made. For example, the number of the jackbolts might be varied. Still further in some applications, the jackbolts might be omitted altogether. The drawings do illustrate a separate bolt member 13 with a head 20, shank and threaded portion 14 opposite to the head 20. It will of course be recognised that a pin or stud member could be rigidly connected to one of the two parts or assemblies to be interconnected, the pin or stud member having a threaded section at its free end.

1. A fastener assembly for securing a first member or assembly to a second member or assembly, the fastener assembly including a pin, stud or bolt with a screw thread formation on a shaft portion, the thread formation being cooperable with a threaded nut member, the fastener assembly further including a cup shaped cover member with a continuous wall structure having an internal surface defining an internal space, the continuous wall structure having an open mouth region with a continuous peripheral edge zone, said internal surface of said cover member having first snap-in formation means cooperable with second snap-in formation means on an outer surface region of the threaded nut member to secure said cover member to said threaded nut member, and in use when so secured, said continuous peripheral edge zone is positioned closely adjacent to a first region surrounding said threaded nut member, said first and said second snap-in formation means being configured to either prevent rotation of said outer cover member relative to said threaded nut member, or if relative rotation is possible, said first and said second snap-in formation means remain engaged upon such relative rotation.

2. A fastener assembly according to claim 1 wherein said cover member includes a continuous seal member positioned along said continuous peripheral edge zone whereby, in use, said continuous seal member is sealed to said first region surrounding said threaded nut member upon interengagement of said first and said second snap-in formation means.

3. A fastener assembly according to claim 1 wherein said internal space is filled or substantially filled with a blocking filler material configured to, in use, minimize or prevent ingress of corrosive or other contaminant materials passing into contact with said pin, stud or bolt or said threaded nut member.

4. A fastener assembly according to claim 1 wherein said first member or assembly is a vibration exciter device and said second member or assembly is a vibratory screening apparatus having at least one screening deck or vibratory feeder apparatus.

5. A fastener assembly according to claim 1 wherein said outer surface region of the threaded nut member includes drive surfaces cooperable with a manual or powered tool member to rotate said threaded nut member relative to the threaded shaft portion.

6. A fastener assembly according to claim 5 wherein said drive surfaces are configured to engage with a hexagonal head engagement tool member.

7. A fastener assembly according to any claim 1 wherein the outer surface region of the threaded nut member has at least two axially formed zones, a first outer zone being of smaller transverse size than a transverse size of a second inner zone.

8. A fastener assembly according to claim 5 wherein the outer surface region of the threaded nut member has at least two axially formed zones, a first outer zone and a second inner zone, and wherein the drive surfaces are formed on said first outer zone.

9. A fastener assembly according to claim 8 wherein said second snap-in formation means are formed on said first outer zone.

10. A fastener assembly according to claim 1, wherein a multi jackbolt tensioner assembly is utilised as the threaded nut member, said multi jackbolt tensioner assembly having a nut body and a plurality of threaded jackbolt members positioned about a central threaded bore engageable with the thread formation on the shaft portion, each of said threaded jackbolt members being threadable through threaded bores in the nut body.

11. Treatment apparatus having at least one member or assembly vibrated by at least one vibration exciter device mounted to said treatment apparatus by at least one fastener assembly including a pin, stud or bolt with a thread formation on a shaft portion and a threaded nut member engaging with said thread formation on the shaft portion, the fastener assembly further including a cup shaped cover member with a continuous wall structure having an internal surface defining an internal space, the continuous wall structure having an open mouth region with a continuous peripheral edge zone, said internal surface of said cover member having first snap-in formation means cooperable with second snap-in formation means on an outer surface region of the threaded nut member to secure said cover member to said threaded nut member, and in use when so secured, said continuous peripheral edge zone is positioned closely adjacent to a seal region surrounding said threaded nut member, said first and said second snap-in formation means being configured to either prevent rotation of said outer cover member relative to said threaded nut member, or if relative rotation is possible, said first and said second snap-in formation means remain engaged upon such relative rotation.

12. Treatment apparatus according to claim 11 where said cover member includes a continuous seal member positioned along said continuous peripheral edge zone whereby, in use, said continuous seal member is sealed to said seal region surrounding said threaded nut member upon interengagement of said first and said second snap-in formation means.

13. Treatment apparatus according to claim 11 wherein said internal space is filled or substantially filled with a blocking filler material configured to, in use, minimize or prevent ingress of corrosive or other contaminant materials passing into contact with said pin, stud or bolt or said threaded nut member.

14. Treatment apparatus including one or more fastener assemblies according to claim 1.

15. Treatment apparatus according to claim 11 wherein a multi jackbolt tensioner assembly is utilised as the threaded nut member, said multi jackbolt tensioner assembly having a nut body and a plurality of threaded jackbolt members positioned about a central threaded bore engageable with the thread formation on the shaft portion, each of said threaded jackbolt members being threadable through threaded bores in the nut body.

16. A cover member for use with a fastener assembly having a pin, stud or bolt with a screw thread formation on a shaft portion and a threaded nut member threadingly engageable with the screw thread formation on the shaft portion of the pin, stud or bolt, said cover member having a continuous wall structure in a cup shape having an internal surface defining an internal space larger than at least said threaded nut member, the continuous wall structure having an open mouth region with a continuous peripheral edge zone and a continuous seal member positioned along said continuous peripheral edge zone, said internal surface of said cover member having first snap-in formation means cooperable with second snap-in formation means on an outer surface region of the threaded nut member, in use, to secure said cover member to said nut member, said first snap-in formation means, either alone or in combination with said second snap-in formation means either prevent rotation of said cover member relative to said threaded nut member, or if relative rotation is possible, said first and said second snap-in formation means remain engaged upon such relative rotation, said first snap-in formation means being configured such that when engaged with said second snap-in formation means, said continuous seal means is operable, in use, to seal said internal space.

17. A cover member according to claim 16 wherein said continuous peripheral edge zone has a mounting zone for said continuous seal member, said mounting zone including a ring groove formation.

18. A cover member according to claim 16 wherein said continuous wall structure has a first zone axially more distant from said continuous peripheral edge zone and a second zone axially adjacent said continuous peripheral edge zone, each of said first zone and said second zone having a circular cross-section with said first zone having a smaller diameter than that of said second zone.

19. A cover member according to claim 18 further including a third zone of circular cross-section positioned axially further away from said continuous peripheral edge zone than said first zone, said third zone having a smaller diameter than said first zone.

20. A cover member according to claim 16 wherein said first snap-in formation means are formed on the internal surface of said first zone, said first snap-in formation means being at least one continuous groove extending into said internal surface or at least one continuous rib extending from said internal surface into said internal space.

21. A cover member according to claim 20 wherein said first snap-in formation means include multiple axially spaced said continuous grooves or multiple axially spaced said continuous ribs.

22. A cover member according to claim 20 wherein said groove(s) or said rib(s) are not continuous but, in use, remain engaged with the second snap-in formation means regardless of rotational position of said cover member relative to said nut member.

23. A cover member according to claim 16 wherein said cover member is constructed of a corrosion resistant material.

24. A cover member according to claim 16 wherein the cover member is moulded from a polymer material including polyurethane.
